(19) United States
(12) Patent Application Publication
(10) Pub. No.: US 2021/0071855 A1
(43) Pub. Date: Mar. 11, 2021

(54) MULTIFUNCTION LIGHTING CONTROL UNIT

(71) Applicant: Cello Lighting, Inc., San Jose, CA (US)

(72) Inventor: Chenghung Pan, Palo Alto, CA (US)

(21) Appl. No.: 16/881,953

(22) Filed: May 22, 2020

Related U.S. Application Data
(60) Provisional application No. 62/897,344, filed on Sep. 8, 2019.

(51) Int. Cl. F21V 23/04; H05B 47/165; H05B 47/16

(52) U.S. Cl. CPC F21V 23/045; F21V 23/0464; F21W 2131/103; H05B 47/165; H05B 47/16; F21V 23/0478

(57) ABSTRACT

A timing-cell for controlling an outdoor lamp such as a streetlight includes a time-based switch and a camera module. The time-based switch may be configured to switch the lamp on or off based on daily sunset and sunrise times at a location of the lamp. The camera module may collect image data and transmit the data to a remote location, and the camera module may be adapted as a motion-triggered surveillance camera to capture video in an environment around the lamp. Multiple timing-cells on outdoor lamps may be connected to a network and used in a Smart Map Security System to track people or vehicles moving through an area of the lamps, to inspect facilities in the area, or provide navigation information to vehicles in the area.

### CROSS-REFERENCE TO RELATED APPLICATIONS

This patent document is claims benefit of the earlier filing date of U.S. provisional Pat. App. No. 62/897344, filed Sep. 8, 2019, which is hereby incorporated by reference in its entirety.

### BACKGROUND

The present disclosure relates to a timing-cell for use in outdoor lighting applications, smart map security systems, surveillance systems, and systems for recording sports activities.

“Dusk-to-dawn” devices such as photoelectric cells, photo-electronic light controllers, or photocells are commonly used to turn on and off outdoor lighting such as streetlights. These devices sense ambient light and particularly sense whether the ambient light is above or below pre-determined levels. A dusk-to-dawn device may, for example, act as a power switch that is on when a measured ambient light level are below a predetermined level and is off when the measured ambient light level is above a predetermined level. Alternatively, light level measurements from a dusk-to-dawn device may be provided to an electronic control circuit that activates a streetlight when incident light that the light sensor measures is below a predetermined level and deactivates the streetlight when the incident light on the light sensor is above a predetermined level.

Photocell sensors may function improperly when poorly set. For instance, if a trigger level of a “dusk-to-dawn” streetlight is set too high, the streetlight may be activated in the middle of day when the day is rainy or cloudy. If a trigger level of a dusk-to-dawn streetlight is too low, the streetlight may remain off even though the sun has set and visibility without lighting is poor. Photocell sensors also suffer from aging and weathering that may change the measurement generated from a constant level of ambient lighting. When the measurement response of a photocell sensor changes, the photocell sensor may leave a streetlight permanently lit or permanently dark, and a city, municipality, or other facilities manager might not know of a street lighting problem until an injury or complaint results.

A city, municipality, or other facilities manager may not only want to control when streetlights turn on and off but may also want to collect measurements from streetlights, for example, to ensure each streetlight is operating efficiently. Remote monitoring or data collection from street lighting may particularly be desired not only for lighting efficiency but also to prevent, monitor, or provide evidence regarding criminal or other human activities. Various solutions for remote monitoring areas around streetlights have been proposed that include mounting a camera on streetlights having photocells. For example, PCT Pub. No. WO2016/156401, entitled “Smart City Closed Camera Photocell and Streetlight Device;” European Pat. App. Pub. No. 2827578, entitled “Virtual video patrol system and components therefor;” U.S. Pat. App. Pub. No. 2011/0134239, entitled “Efficient Illumination System for Legacy Street Lighting Systems;” U.S. Pat. No. 5,886,738, entitled “Apparatus within a streetlight for remote surveillance;” and U.S. Pat. No. 6,462,775, entitled “Apparatus within a streetlight for remote surveillance having directional antenna” describe lighting systems with at least some monitoring or communication abilities. A particular problem with street lighting systems using cameras for data capture or security monitoring is the huge amount of video data that is generated and needs to be organized to become useful.

### BRIEF DESCRIPTION OF THE DRAWINGS

FIG. 1 illustrates a multifunction lighting control unit including a timing-cell enclosed in an water and dust sealed housing according to an example of the present disclosure.

FIG. 2 illustrates a socket of a lighting control unit according to an example of the present disclosure.

FIG. 3 shows a streetlight or other outdoor lighting structure with an installed lighting control unit according to an example of the present disclosure.

FIG. 4 is a block diagram showing major functional modules in a lighting control unit in accordance with an example of the present disclosure.

FIG. 5 schematically shows a system employing a network of lighting control units on streetlights.

FIG. 6 schematically shows a system employing a network of lighting control units on outdoor lighting in a recreational area such as a slope at a ski resort.

The drawings illustrate examples for the purpose of explanation and are not of the invention itself. Use of the same reference symbols in different figures indicates similar or identical items.

### DETAILED DESCRIPTION

In accordance with an aspect of the present disclosure, a multifunction control unit for controlling a streetlight or other outdoor lighting may switch lighting on and/or off without using any photocell or other light sensors and may include multiple modules for data collection, characterization, and communication. The control unit may be a Closed Camera Timing Cell (CCTC) configured to control lighting and collect and transmit image data to a remote location, and the CCTC may be adapted as a motion-triggered surveillance camera to capture and record video or images of a scene in a region of interest, for example, when human or vehicular motion is detected. Additionally, a Smart Map Security System (SMSS) module may be configured to integrate the image/audio data recorded by the CCTC system with a smart map system so that users can track the routes of activities of targeted incidents by reviewing the recorded image/audio data that is synchronized with a smart map.

A lighting control unit may employ a programmable timer to control operation of a streetlight or other outdoor light fixture. The timer may be set according to a sunrise-sunset calendar that is customized for the location of the light fixture controlled, and the calendar (or sunrise-sunset information in another form) may be uploaded to the lighting control unit through a communication interface, e.g., a network interface. A top-level controller in the lighting control unit or a remote station may use the sunrise-sunset information in setting the programmable timer and determining when to operate a switch or a dimmer to turn on, turn off, or reduce the power supplied to the light fixture. Use of time-based switching, avoids the need for a photocell or other light sensor and avoids the problems with that may result from the aging or failure of a light sensor, and use of programmable power reduction or dimming may further optimize energy efficiency when providing desired outdoor lighting.

The communications capabilities of the lighting control unit may further permit a remote manager to collect information from the lighting control unit (and similar lighting control units in other light fixtures) to monitor and optimize performance of outdoor lighting. The outdoor lighting control unit may further include imaging and other sensing capabilities that leverage processing and communication capabilities. Sensing may be used to measure energy consumption and sense conditions, e.g., temperature, the presence of smoke, pollution, or specific chemicals, wind speed and direction, noise, and movement in the environment or surrounding area of the light fixture. Imaging may be used to document activities in the area of the light fixture, for example, to detect or measure traffic, detect crime, record evidence of a crime, or document recreational or entertainment activities. The imaging may be or may be similar to closed circuit television, and the control unit may particularly implement smart closed circuit television that triggers image data transmission in response to specific events such as detection of motion or more complex conditions.

A network of lighting control units may be employed in outdoor light fixtures such as streetlights or outdoor lighting for recreational activities that are distributed to cover an area, and information or images from different lighting control units may track activities that move through the covered area. For example, movement of a pedestrian or a vehicle may be tracked as the pedestrian or vehicle moves along streets that streetlights would illuminate at night. The tracking capabilities, which may be used day or night, may be useful for documenting the movement of crime suspects such as hit and run drivers or to track any activities that move across an area covered by the network of light fixtures. Tracking capabilities may be useful in recreational areas such a ski resorts to record performances that travel across an extended area, e.g., a skier navigating the length of a ski slope, and such recordings from multiple lighting control units may be stitched together into a video as a souvenir or for training purposes.

A lighting control unit may employ a standard socket commonly employed by conventional photocells or may otherwise be wired to replace a conventional photocell. An extended system such as a set of streetlights spread throughout a municipal area may thus be retrofitted to convert a simple lighting system into a smart lighting and data collection system that provides enhanced monitoring and control of lighting and provides additional functionality such as surveillance, environmental measurements, or image/audio recording. A streetlight with a lighting control unit in accordance with some examples of the present disclosure will generally look the same a streetlight with a conventional photo-cell mounted on the streetlight. Security capabilities of the streetlights may thus be unseen to the public.

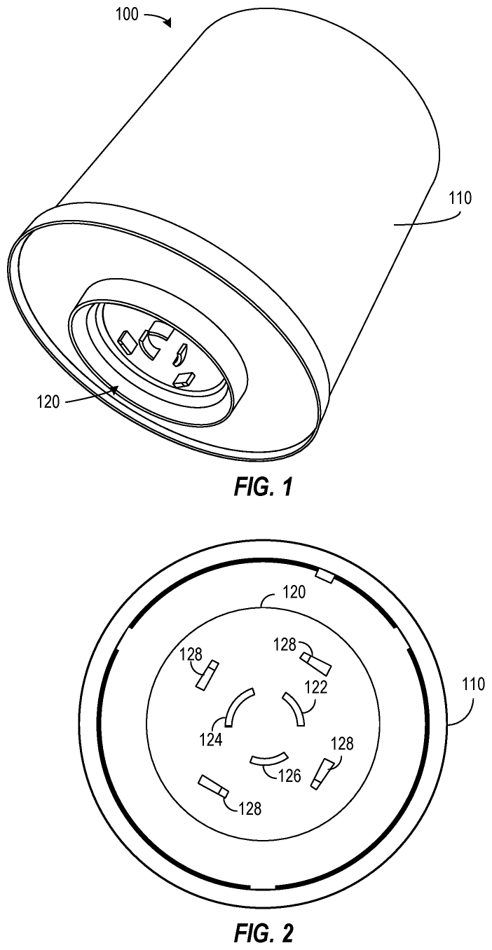

FIG. 1 shows a perspective view of a lighting control unit 100 in accordance with one example of the present disclosure. In general, lighting control unit 100 includes a housing 110 that is weatherproof to protect internal circuitry from dust and moisture. Housing 110 may, for example, be an IP67 rated housing capable of protecting enclosed electrical circuits from water up to a meter deep for at least one half hour. Housing 110 has a socket or electrical connector 120, which may be positioned on the bottom of housing 110 and may have a standardized configuration for replacement of conventional photocells on streetlights or other outdoor light fixtures. In particular, socket 110 may be an ANSI C136.41 socket, so that lighting control unit 100 can be used in place of a convention 3-pin NEMA photo cell. Alternatively, lighting control unit 100 may be a 7 pin NEMA socket device.

FIG. 2 shows a bottom view of an example of a lighting control unit 100 having a socket 120 on a bottom of housing 110. Socket 120 in the illustrated example is a 7-pin socket and may, for example, include electrical power pins 122, 124, and 126 and four signal pins 128. Electrical power pins 122, 124, and 126 may respectively be for a common or ground, an input line voltage, and a switched output voltage, and pins 122, 124, and 126 may be rated to handle a convention power supply, e.g., 110 V at 60 Hz or 220 V at 50 or 60 Hz, at currents, e.g., about 10 to 25 amps, sufficient to operate a streetlight or other outdoor light fixture. One function of lighting control unit 100 may be to control the time that a streetlight is powered, and lighting control unit 100 may receive electrical power through pins 122 and 124 and provide switched power through pins 124 and 126. Signal pins 128 may serve the purpose of dimming control or may be reserved for other alternative control signals. Pins 122, 124, 126, and 128 or surrounding structure of socket 120 may be shaped or otherwise designed to provide a twist-lock connection of socket 120 to a complementary socket on an outdoor light fixture such as a streetlight.

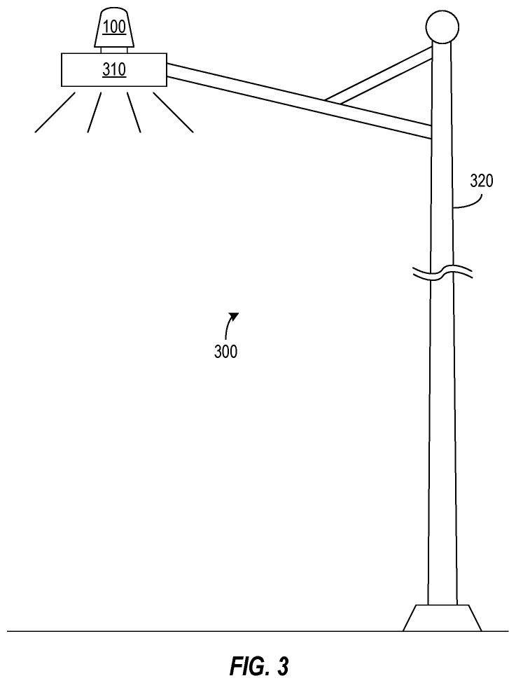

FIG. 3 shows a lighting control unit 100 employed on an outdoor light fixture 300 such as a streetlight. Lighting control unit 100 may particularly be mounted on or in or underneath a canopy of a light source 310, which is mounted on a support structure 320 such as a light pole. Light source 310 may, for example, be a high-intensity LED system, a high-pressure sodium vapor lamp, a mercury vapor lamp, a fluorescent lamp, or similar light source that is capable of operating in an outdoor environment and of illuminating a sufficient area around outdoor light fixture 300. Support structure 320 holds light 310 in position for illumination of the surrounding environment and may contain wiring (not shown) to supply electrical power through lighting control unit 100 to light source 310 or shielded or coaxial cables for data or video signals. Support structure 320 may be any type of conventional light pole or telephone pole on which light source 310 is mount. Alternatively, support structure 320 may be a natural structure such as tree or may be a building or other edifice with a mounting capable of supporting the weight of light source 310 and providing electrical power to lighting control unit 100. Lighting control unit 100 may be mounted on light source 310 or support structure 320 and may particularly be coupled directly into an electrical socket that light fixture 300 conventionally uses for a photocell sensor.

Lighting control unit 100 when installed in a light fixture 300 may perform multiple functions not limited to dusk-to-dawn switching of illumination. In particular, lighting control unit 100 may be a Closed Circuit Timing Cell (CCTV) with equipment or modules for normal timing-cell functions and for some form of closed circuit video/audio transmission. Lighting control unit 100 may also deliver other services such as: streetlight management service (SLMS), presence detection, traffic monitoring, environmental pollution monitoring, EV (Electrical Vehicle) and driverless vehicle control information, street, pavement and road digital photographic services and street map photographic services along with CCTV services.

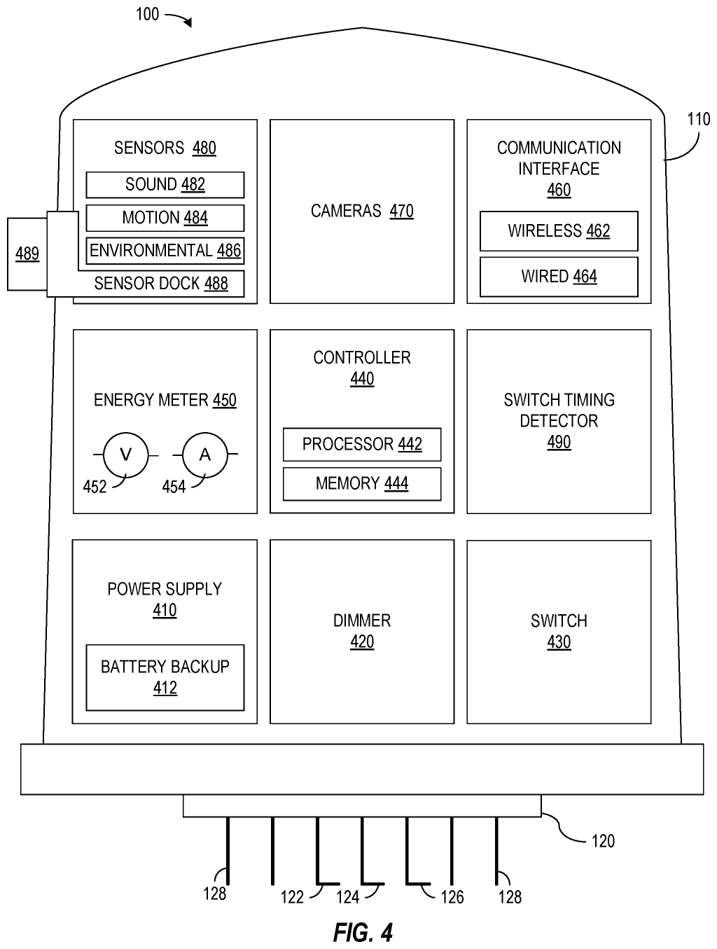

FIG. 4 shows a block diagram of outdoor lighting control unit 100 according to an example implementation including multiple modules 410, 420, 430, 440, 450, 460, 470, 480, and 490 at least partially incorporated within a sealed housing or enclosure 110 in one example of the present disclosure. In the illustrated example, lighting control unit 100 includes a power supply module 410 that receives electrical power from pin 122 and supplies electrical power through a dimmer 420 and a switch 430 to an outdoor light fixture on which lighting control unit 100 is mounted. Power supply 410, for example, receives electrical power from input pin 122 and common pin 124 of socket 120 and provides electrical power to the light fixture through switched pin 126. Power supply 410 also provides power to all the other modules 440, 450, 460, 470, 480, and 490 of lighting control unit 100. Power supply 410 may receive a line voltage, e.g., convention household supply at 110 V or 220 V, output unconverted power through dimmer 420 and switch 430, and provide transformed or converted electrical power as needed for some or all other modules in lighting control unit 100. Power supply 410 may, for example, convert AC line power to 12 volt DC power for CCTV circuits, integrated circuits (ICs) or other circuitry in modules that provide data acquisition, processing, and communications. In the illustrated example, power supply 410 includes a battery backup 412 that may be used to provide or continue data acquisition, processing, or communications in the event of a power outage. In general, battery backup 412 does not need and may be unable to supply power for lighting but may be sufficient for other functions of lighting control unit 100 as describe further below. Similarly, power supply 410 could employ solar, thermal, or mechanical energy harvesting as a power source in place of or in addition to battery 412. In particular, housing 110 may be transparent or include a window for a photovoltaic power cell.

Dimmer 420 and switch 430 may be coupled in series to switched pin 126, and a top-level controller 440 in lighting control unit 100 may operate switch 430 to turn on or turn off a current flow through switch dimmer 420 and may operate dimmer 420 to control the brightness of a light source that receives power when switch 430 is in an “ON” state.

Controller 440 may also operate other modules of lighting control unit 100 and particularly operate a communication interface 460 for communications with systems outside lighting control unit 100, an energy meter 450 to measure power consumption of lighting control unit 100 and devices connected to lighting control unit, camera module 470 to capture images or video of an area surrounding light control unit 100, sensors 480 to monitor the surroundings of lighting control unit 100, and a switching timing detector 490 to control the timing for switching on or switching off the switch 430. In some alternative examples, lighting control unit 100 only includes a subset, e.g., two or more, of modules 410, 420, 430, 440, 450, 460, 470, 480, and 490.

Lighting control unit 100 has a socket 120 that may be connected to an outdoor light fixture such as described above with reference to FIG. 3. A primary function of lighting control unit 100 may be to use switch 430 to provide dusk-to-dawn lighting or illumination from the outdoor light fixture, i.e., to turn on the light at dusk and turn off the light at dawn. Lighting control unit 100 may further use dimmer 420 to dim or otherwise reduce power consumption of the light fixture. For example, lighting control unit 100 may vary the brightness of illumination from a light fixture based on the time of day or on sensing particular trigger events such as motion in the area of lighting control unit 100. With dimmer 420, lighting control unit 100 can control not just whether power is supplied to a light fixture but also the amount power supplied to the outdoor light fixture. Lighting control unit 100 may use timing information generated by switch timing detector 490, rather than measurement of ambient light, to determine when to turn a lamp on or off (and to change the amount of power supplied to the lamp). The switch 430 may be directly controlled by controller 440 to open or close the circuit. For example, controller 440 may operate switch 430 to turn “ON” a streetlight once a real-time clock, which might be located inside the unit 110 or located at a remote server, reaches a “dusk time” for the location of lighting control unit 100 and the date of operation of timing cell switch 430 and may turn “OFF” the streetlight when the real-time clock reaches a “dawn time” at the location and date of operation. While a light fixture is powered, controller 440 may set dimmer 420 to change the amount of power supplied to the light fixture. Controller 440 in lighting control unit 100 or a manager that is remote from lighting control unit 100 may determine the dusk and dawn times from a calendar of sunrise and sunset times for the location (or latitude) of the light fixture that lighting control unit 100 controls. In general, users, depending on their preference, have the liberty to set up the “dusk” time to be slightly before, after or exactly at the sunset time. Similarly, users can set up the “dawn” time to be slightly before, after or exactly at the sunrise time. (In general, dusk and dawn times may differ from sunrise and sunset times.)

Controller 440 may be the top level controller of lighting control unit 100, which means that controller 440 controls top level behaviors of all other modules in lighting control unit 100, but other modules 410, 420, 430, 450, 460, 470, 480, and 590 may be programmable. For example, controller 440 may set on and off times in switch 430, while switch 430 tracks current time and performs the dusk-to-dawn switching operations. Controller 440 in lighting control unit 100 may include a microcontroller or microprocessor 442 and memory 444 for storage of data, e.g., acquired measurements or image data as described further below, and software or firmware that processor 442 may execute. As described further herein controller 440 may be configured to execute processes for operation dimmer 420 and switch 430 to power an outdoor light source, to communicate with and execute commands from a remote manager, a local area unit, or a on-site control device, and to collect, analyze, format, and transmit acquired image data and measurements from energy meter 450, cameras 470, and sensors 480.

Energy meter 450 in lighting control unit 100 may measure power consumed by lighting control unit 100 and the light fixture or other electrical systems powered through switch 430. In an example implementation, energy meter 450 includes both a voltage sensing device 452 and a current sensing device 454, for example, route mean square (RMS) voltage and current meters. To deliver smart energy meter services, energy meter 450 or controller 440 may include memory 444 used for storage of energy consumption measurements, for example, to hold the energy consumption measurements until lighting control unit 100 receives a command to transfer the measurement data through communication interface 460. Energy meter 450 also enables controller 440 to execute a process for monitoring electrical energy consumption of the connected light fixture and other electrical systems that may be powered through switch 430 and for monitoring the energy consumption of lighting control unit 100 itself. To measure the energy consumption of the connected light sources and other circuits, energy meter 450 may be class 1 electrical energy meter. Energy consumption monitoring with the “dusk-to-dawn” timed operation allows accurate energy consumption control of any connected devices such as a streetlight, internal circuits of the streetlight, and any module or apparatus connected to the streetlight.

Communication interface 460 allows lighting control unit 100 (and particularly controller 440 or camera module 470) to communicate through a network to remote devices. In an example implementation, communication interface 460 provides communicates with a Local Access Unit (LAU), which may provide access to a wide area network such as the Internet and to any station available through the wide area network or the Internet. In general, a municipal or private lighting system may include a number, e.g., hundreds or thousands, of outdoor light fixtures with control units 100 distributed over an area that may span square miles, and multiple LAUs may be used as control or transfer centers for monitoring and controlling the outdoor light fixtures in associate areas. Communication interface 460 in a lighting control unit 100 may enable communication to an LAU that is the system control station or through the LAU to a system control station. In some example implementations, a wireless communication module 462 of communication interface 460 may include hardware for implementation of a wireless network communication protocol such as WiFi, 4G/LTE, or 5G, and a wired network communication module 464 may include hardware for implementation of an RS-232 serial port, Ethernet or other wired data transmissions, e.g., 0-10 Volt or Dali®, through dedicated signal lines. In an alternative implementation, power lines may provide communications as described in U.S. patent application Ser. No. 16/539,833, entitled “LIGHTING-BASED SENSING AND REPORTING,” which is hereby incorporated by reference in its entirety. Controller 440 communicating through power lines, e.g., pin 122, may particularly employ dimmer 460 to vary the power supplied to the light fixture according to a predetermined temporal pattern that represents information, and the LAU may measure the power consumed on the power line and decode the pattern of power variations to determine the communicated information. A control station may be part of the LAU, or the LAU may transmit the information to the control station through other communication links such as the Internet. Communication interface 460 may further permit communications through a local network device such as a router that interconnects multiple lighting control units 100 and provides a gateway to a wide area network or public network such as the Internet. The LAU for a lighting system may have the ability to receive the information from hundreds or thousands of similar lighting control units 100 and may pass the data on to a customer or a client's data storage or cloud storage servers.

Communication interface 460 may further incorporated hardware for communicating at short distances. For example, wireless communication module 462 may implement a protocol such as Bluetooth to communicate with maintenance personnel or emergency services employing portable computing devices such as smart phones, iPads® or laptop computers. A control panel (not shown) on lighting control unit 100 or the connected light fixture may similarly be used to provide commands to lighting control unit 100. Short distance communications may be desired to convey information such as diagnostic information regarding lighting control unit 100 or the light fixture to onsite maintenance personnel.

Camera module 470 may include one or more cameras positioned in lighting control unit 100 to observe an area or environment around lighting control unit 100 and to provide closed-circuit television (CCTV) capabilities. Camera module 470 may use visible light or light outside the spectrum visible to humans to capture images of an environment around control 100. Visible light, however, may be sufficient since lighting control unit 100 may be located on an outdoor lamp that illuminates the environment at night. Camera module 470 may include optics, solid-state image sensor (CCD or CMOS), image processor(s) and supporting hardware, an output generator, and communication ports and outputs and inputs to and from sensors 480, e.g., motion sensing and sound pick up circuits. Camera module 470 may further include one or more processors to perform some image related tasks such as color interpolation, color correction or saturation, gamma correction, image enhancement and camera control such as white balance and exposure control, signal level processing, image segmentation, feature level processing, feature extraction, feature measurements and tracking, object level processing and object classification and estimation. Camera module 470 may further include an output generator such as an NTSC/PAL encoder to provide standard TV-compatible output or such as a video compression engine to provide compressed video streams or digi-photo buffers for communication over a network through communication interface 460. Camera module 470 (or communication interface 460) may include an in-built IPv6 communication circuit that is an integral part of lighting control unit 100. In some implementations, camera module 470 may feed one or more video stream into controller 440, which forwards image data, e.g., a single scanned frame at a time. Alternatively, camera module 470 may directly provide a closed circuit feed through communication interface 460 or signal pins 128.

Housing 110 may be transparent, e.g., transparent glass or plastic, or may include one or more windows for the field(s) of view cameras in camera module 470. Camera module 470 may use multiple miniature or micro cameras to provide a collective 360° field of view around lighting control unit 100, although a smaller field for view may be sufficient for many applications and use of a camera with a motorized camera mount is possible. Camera module 470 may include micro cameras and circuits mounted on a circular printed circuit card, so that the mounting of the circuit card takes into account all of the required surveyed area up to 360° if required. Control software can select a particular camera in module 470 to deliver particular surveillance observation or concentrate on a particular angle or area. The term CCTV is used herein because camera module 470 may be used with remote monitors and/or video recorders, e.g., at the LAU or a remote control station, that receive image data across a proprietary communication link through communication interface 460 (directly or via controller 440) or through a direct wired connection such as a coaxial cable, e.g., coupled to signal pins 128. Access to image transmissions may be limited to the system manager or the LAU.

Sensors 480 in lighting control unit 100 may be used to measure or sense a variety of events or characteristics in the area around lighting control unit 100. Sensors 480 may, for example, include a microphone or other sound sensing system 482, a motion detector 484, and environmental sensors 486 such as an optical smoke detector, a radiation detector, or a temperature sensor to name a few. Environmental sensors 486 may monitor of environmental pollution among environmental aspects of the area surrounding lighting control unit 100. Many types of pollution sensors have a relatively short working life in the field, for example, because sensors 486 may get contaminated with airborne pollutants. As such, some sensors 480 may need to periodically replaced, exchanged, or otherwise maintained. Lighting control unit 100 may have one or more docking features 488 to allow some of sensors 489 to be attached outside of housing 110 and to be hot swapped safely with the use of a simple tool. Docking features 488 may provide the ability to transfer power and communications through sealed housing 110 to at least some sensor units 480, particularly sensors 486 that detect airborne pollution or sound sensors 482. Depending on the power demands and the communication requirements of the individual sensor types, sensor dock 488 may employ a number of solutions to interface one or more of sensor 480 with the rest of lighting control unit 100. For example, sealed metal contacts may be embedded in the wall of housing 110 providing safe electrical power and communication connections while maintaining the weatherproof seal of housing 110. Sound sensor 482 or motion sensor 484 may provide triggers for processes that lighting control unit 100 performs. For example, if motion sensor 484 detects pedestrian movement in the area, controller 440 may respond by turning on or increasing the brightness of lighting from the connected light source or may activate cameras 470 or other sensors 480. If a noise is detected and determined to indicate a gunshot or explosion, controller 440 may respond by transmitting an alarm or warning message through communication interface 460 to the LAU, a law enforcement facility, or any desired recipient(s). Sensors 480 may further include a GPS receiver to constantly update all coordinates for rapid ease of identification of lighting control unit 100 based on location. A GPS receiver may be used during installation or commissioning of lighting control unit 100 to determine and store, e.g., in memory 444 or a remote device, coordinates for a streetlight or other outdoor light fixture. For example, at time of installation, GPS coordinates and unit serial number readings and details of lighting control unit 100 can be transmitted to and stored in an asset management database for later use, e.g., when setting times at which an outdoor lamp is turned on or off.

A comprehensive streetlight diagnostic program located in remote server may be employed to monitor all aspects of the streetlight lamp operation, e.g., operation of an LED driver and light engine, and may report back burning hours, length of time the streetlight is switched on, power consumed information and power consumed and saved during the dimming modes.

Outdoor lighting control unit 100 can enable streetlight management service (SLMS) when employed in a system of streetlights. Municipalities generally want to remotely manage all street lighting assets and particularly want to manage energy use and optimize energy efficiency. Controller 440 may provide a platform that provides always on data plus the ability to process streetlight control commands so that a remote manager can maintain greater control of the streetlight. A municipality may thus monitor streetlights and control the operation of the streetlights. Energy meter 450 allows a manager to also receive and record the energy used by the streetlight, and the manager may save energy by commanding lighting control unit 100 to dim or switch “off” the streetlight at low demand times, e.g., late night when no movement or people are in the area of the streetlight. All other ancillary equipment connected to the light poles may also be monitored or controlled. Such ancillary equipment may include, for example, advertising and display signs, festive electrical decorations, information signs, on-street pedestrian visual displays, navigation devices for driverless vehicles, or electrical vehicle chargers to name a few.

Lighting control unit 100 may further have information capabilities in addition to lighting or power control functions. CCTV capabilities of camera modules 470 in multiple lighting control units 100 may be used for wide area surveillance and security purposes in a public setting or may be used for entertainment or training in facilities or areas in which users may want to record activities for remembrance or training. Some security functions of a network of lighting control units 100 may include maintaining perimeter security, monitoring traffic, obtaining visual records of human activities, environmental observance, footfall data collection, and tracking of routes of activities. Some entertainment or training functions may include using cameras 470 in multiple lighting control units 100 at different locations in sporting area such as on a ski slope to record a participants activity over an extended area, e.g., a skier's run down the slope. Such multi-camera tracking of a sports or entertainment activity may provide a souvenir video commemorating the activity or may facilitate review of the performance of the activity for evaluation and training that improves techniques. For monitoring, security, entertainment, or training functionality, cameras 470 in lighting control units 100 may need strategic placement to cover an extended area, and the placement criteria for recording activities in an extended area are often similar or identical to the placement criteria for lighting that covers the area. In particular, outdoor light fixtures are typically positioned to collectively cover an entire area to be illuminated for human activities, and lighting control unit 100, which may ideally mounted in an locations right on top of the canopies or underneath the streetlights, have clear views of the same areas. Another feature of the CCTV capabilities in lighting control unit 100 is that camera module 470 may be used when artificial lighting is not require, but the controlled light source, e.g., white LED lighting, may be excellent for lighting up the area surrounding the light fixture when lighting is needed for imaging.

Cameras 470 by themselves or when used in combination with other modules such as controller 440 and sensors 480 may act as smart cameras that process data, e.g., image data with contemporaneous sensor data, where and as the data becomes available. Data may particularly be characterized into specific types. A characterization may, for example, indicate whether image data shows activity that needs to be transmitted to a monitor that handles an identified type of activity such as a fire or a vehicular collision, is data that may be transmitted to storage where the data may later be interrogated or further analyzed either on a private or cloud based computer server, or data that may be discarded such as image data showing no activity in the monitored area. A smart camera is ‘smart’ because a smart camera is able to perform application specific information processing (ASIP), a goal of which may be to provide relevant information and better quality images for human viewing. Better quality images can be achieved by adjusting the trade-off between the shutter speed and the influx light quantity. For instance, when the shutter speed is fast, it is easier to recognize the license plate number at higher speed. However, too high shutter speed would reduce the influx light into the optical sensor inside the camera 470. Consequently, the smart camera ASIP may need to tune or set the shutter speed to an optimal speed that depends on the influx light into image sensor and the required image quality. Software can interpret and describe what is happening in the images for the purpose of better decision-making in an automated control system. For example, an LED streetlight may have motion sensors 484 for streetlight activation or dimming when there is vehicular or pedestrian activity, which motion detection could be used to eliminate the need for the constant recording of motionless scenes. By utilizing smart cameras or software, control unit 100 and specifically cameras 470 may only record motion that satisfies certain criteria.

Security capabilities based on imaging have been transformed through recent technological developments and use of internet-based products and systems. For example, image processing software, which may be remote from lighting control unit 100 or executed by controller 440 in a lighting control unit 100, can identify or distinguish individual people or vehicles. In accordance with one example of the present disclosure, an individual person or vehicle may be identified or tagged based on image data captured when the person or vehicle is in the area of one control unit 100 in a network, and tagging information may be used to subsequently identify the person or vehicle in the area of another control unit 100. People or vehicles may thus be automatically tracked through a wide area covered by a patchwork of control units 100 on outdoor light fixtures.

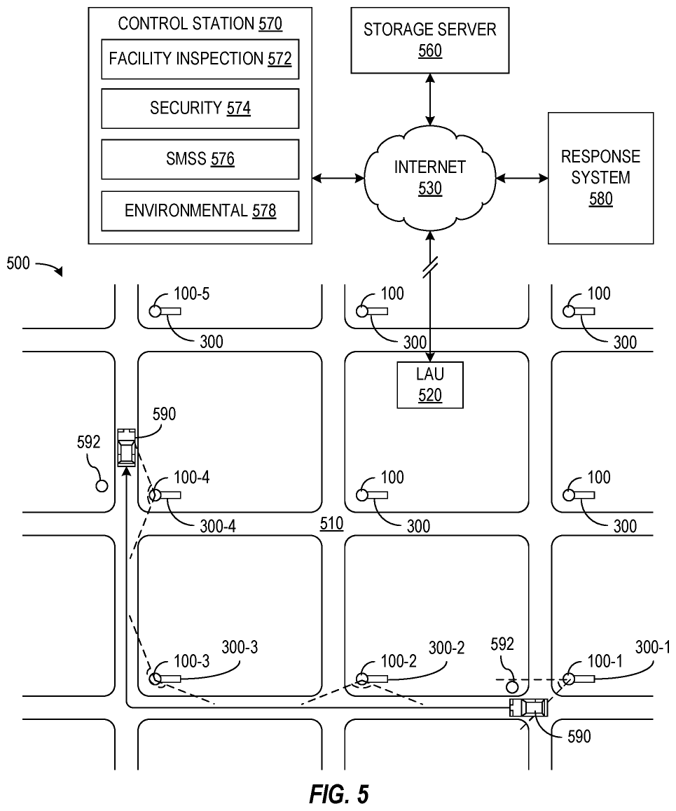

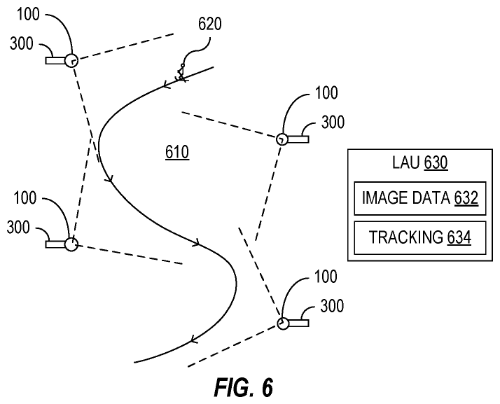

FIG. 5 shows a street lighting system 500 including streetlights 300 positioned to illuminate areas including streets 510 over an extended area, e.g., several city blocks. Each streetlight 300 has a lighting control unit 100 that may have an ID or a geographic location that distinguishes the lighting control unit 100 from other lighting control units 100. Lighting control units 100 are capable of communicating with an LAU 520 through a wireless or wired connection as described above. LAU 520 can receive data from lighting control units 100 and can send commands to specific lighting control units 100. In one example of the present disclosure, lighting control units 100 provide an IP-based CCTV or data transmission system. In particular, each lighting control unit 100 captures image, audio, or other sensor data and transmits the data over a local network or communication link to local access unit 520, which provides a gateway or an Internet connection having dedicated IP address, so that the data captured by lighting control units 100 may be directed through LAU 520 and the Internet or other wide area network to a storage server 560 or a control station 570. Processing and control modules such as a facility inspection module 572, a security module 574, an environmental monitoring module 576, or a mapping module 578 may be implemented using hardware in one or more of lighting control units 100, LAU 520, storage sever 560, or control station 570, but FIG. 5 illustrates an example in which control modules 572, 574, 576, and 578 include software executed by control station 570, which may be a computing system located anywhere that is connected to the Internet.

Facilities inspection module 572 may use CCTV capabilities of control units 100 for inspection of public or private facilities. For example, the pavement of roads or streets 510 and sidewalks along streets 510 may need to be periodically inspected to detect dangerous or undesirable conditions, e.g., potholes, cracks, raised edges, and slippery or uneven surfaces. Facilities inspection conventionally requires vehicles and manpower to travel to inspection sites, and the inspections can be disruptive to pedestrians and vehicular traffic in inspected areas. System 500 allows use of cameras in control units 100 to eliminate or reduce the need for inspectors and equipment that travel to the inspected facilities. In particular, facility inspection module 572 may analyze image data captured by control modules 100 to identify defects or problems, e.g., potholes, cracks, raised edges, and slippery or uneven surfaces on streets or sidewalks. Facilities inspection module 572 may provide images of identified or suspected problems to a human inspector or may automatically generate repair orders to appropriate maintenance crews. In either case, inspectors do not need to travel to inspect sites, which may save money and manpower and reduce carbon emission. Another aspect of inspections carried out through control units 100 is location identification using the GPS coordinates of the control unit 100 that images the problem. In particular, when a problem is identified, the database entry, e.g., a repair order, for the problem can be stored with GPS coordinates for easy retrieval by a maintenance crew that can use the GPS coordinates when traveling to repair the problem. Lighting control units 100 can easily and automatically index image data by time and GPS coordinates, so that the image data can be later analyzed using pattern recognition software or human inspectors that can identify facilities problems and the locations of the problems. For facilities inspection, each lighting control unit 100 may be configured to photograph a defined area for determination of one or more of the following: the condition of the surface of streets 510 or sidewalks in the defined area and the condition of structures such as signs, fire hydrants, mail boxes, public or emergency telephones, and the streetlight column and luminaire of the streetlight 300 on which the lighting control unit 100 is mounted.

Security module 574 may, for example, detect potential emergency events such as explosions, gun shots, or automobile or other vehicle collisions. Sensors in lighting control units 100 may be used to identify particular emergency conditions. For example, analysis of audio data from microphones or other sound sensors in control units 100 may identify sounds with volume, pitch, and temporal profile indicating an explosion, gunshot, or vehicle collision. A control unit 100, LAU 520, or control station 570 may execute an identification process analyzing audio data captured by a lighting control unit 100 and may report results to a response system 580 that may be associated with an appropriate party, e.g., a law enforcement organization, a fire department, or an ambulance.

Security system 574 may also or alternatively identify or track vehicles or people in the area of streetlights 300, and system 500 can provide an intelligent mesh video network which can be used to track the route of an incident. For example, a vehicle 590 or a person 592 may be identified from image data captured by a specific lighting control unit 100-1 at a time T1. Lighting control unit 100-1 may, for example, capture images containing vehicle 590 or person 592 as a result of a continuous imaging of the area around streetlight 300-1 or upon being triggered by an event such as motion detection, noise detection, or unit 100-1 receiving a surveillance command from control station 570. Security module 574 may identify vehicle 590 using pattern recognition processes performed on the image data captured by unit 100-1, to determine the shape and dimensions of vehicle 590. The shape and dimensions may indicated a make and model of vehicle 590. The color of vehicle 590 determined from image data may assist in distinguishing vehicles of the same make and model, and pattern recognition determining a license plate number may uniquely identify vehicle 590. With video data from control unit 100-1, the path and speed of vehicle 590 may be determined for the period in which vehicle 590 remains in the area of lighting control unit 100-1. Detection of the speed of a vehicle may identify unsafe driving and may trigger security module 574 to contact a response system 580 that may be associated with law enforcement. Identifying information for vehicles may be used in construction of a time-indexed database of vehicle identifiers for vehicles including vehicle 590 that passed through the monitored area of control unit 100-1. Security module 574 may similarly use recognition processes to identify person 592 in an image or series of images captured by control unit 100-1. In particular, security system 574 may use facial recognition software to identify selected facial features of individuals in an image or video, and security system 574 may construct a time indexed database of individuals in an area of control unit 100-1. For large crowds in an area, facial recognition techniques may require too much processing power to identify or distinguish people, and as an alternative, gait recognition software may distinguish different people in a group by the ways that people walk or move. People's height, apparel, and other features may also be recorded in a database to tag person 592 in the area of control unit 100-1. The database of vehicles or people constructed for control unit 100-1 may be compared to similar databases for other control units 100 to recognize specific vehicles or individuals in image data from another control unit 100-2 and thereby track movement of a person or vehicle. Cameras 470 may also be used in conjunction with sensors 480 to recognize people or vehicles in the area of a control unit 100.

FIG. 5 illustrates how vehicle 590 or person 592 may move along a path starting at time T1 in the area of control unit 100-1 through the areas monitored by control units 100-2 and 100-3 to an area monitored by control unit 100-4 at a later time T4′ when vehicle 590 may park or enter a garage. A tracking process, for example, can compare the time-indexed database of vehicles or people in the area of control unit 100-1 to similar time-indexed databases constructed for other control units 100. In the illustrated example, matching vehicle 590 or individual 592 in the databases of control unit 100-1 and the database for control unit 100-2 may identify vehicle 590 or individual 592 as being in the monitored area of control unit 100-1 between times T1 and T1′ and in the monitored area of control unit 100-2 between times T2 and T2′. As noted above, a path of vehicle 590 and person 592 in the area of control unit 100-1 may be determined and may identify the database of control unit 100-2 for comparison to the database of control unit 100-1. When a match is found in the database for control unit 100-2, vehicle 590 or person 592 can be documented as traversing the area of streetlight 300-2. Repeating the database comparisons may result in a determination that vehicle 590 or individual 592 was in the monitored area of control unit 100-3 between times T3 and T3′ and in the monitored area of control unit 100-4 between times T4 and T4′. Further, video clips from control units 100-1 to 100-4 may be linked together to document and track the progress of vehicle 590 or individual 592 from the area of control unit 100-1 to the area of control unit 100-4.

A Smart Map Security System (SMSS) module 576 may incorporate a street map service, e.g., Google Map, and the video files captured by multiple control units 100 to connect linked video clips. Each video file captured in system 500 may be tagged with a unique time stamp (year: month: date: hour: minute: second) and a GPS location of the control module 100 capturing the video file, and the video files may be stored in storage server 560 for subsequent uses. In particular, a user may specify a time frame, e.g., start and stop times, and a map location range, so that SMSS module 500 can automatically retrieve and use, e.g., play, the recorded videos in the time sequence within the specified location range. For example, if an investigator knows that an automobile accident occurred at 1:02:10 AM at the specified location within system 500 and the car causing the accident left the scene, the investigator can use the time and location to identify vehicle 590 as the cause of the accident and then a tracking process as described above can track the movement of vehicle 590 from the area of control unit 100-1 to the area of control unit 100-4. All of the motions of vehicle 590 as detected and recorded by control units 100-1, 100-2, 100-3, and 100-4 installed at streetlights 300-1, 300-2, 300-3, and 300-4 may this be stored and available for later construction of a detailed timeline of events from the collision to a location where vehicle 590 may be found.

Security module 574 or environmental module 576 may use sensors 480, including microphones or other sound sensors, motion sensors, temperature sensors, chemical sensors, or other sensors of environmental conditions around control units 100, to detect specific events or to track progression of such events. In particular, sensors 480 in control unit 100 may include a sound pick up circuit that delivers advanced sound tracking, and controller 440 may be used record all types of environmental noise, for example, the sound of gunshots, so as to aid security services and protects the citizens. In some cases, surveillance, recognition, or tracking functions may only be activated when a trigger event such as sensors 480 detecting of a gunshot, explosions, a scream, a cry for help, or high speed movement is detected. Specially designed noise recognition software can be employed to distinguish import sounds from background city noise.

A benefit of including cameras and sensors in lighting control units 100 as opposed to using conventional security equipment is aesthetics. Lighting control units 100 may effectively be invisible to the public or seen as just another normal streetlight timing-cell. Lighting control units 100, however, may provide greater flexibility, better performance, while still being easy to install. Currently streetlights configured for SLMS (Street Light Management System) and other technologies are commonly delivered equipped with a seven pin twist lock socket mounted on the streetlight lantern canopy, control unit 100 can be adapted to plug and twist-lock into this socket by simple hand insertion, e.g., insert twist and lock to installed. No additional cables, no unsightly towers or lattice structures, poles or securing on to third party buildings are needed. Commissioning and integration may also be fast just plug and play for immediate remote surveillance, using internet based special apps that may be made available for smart phones for surveillance controlled wherever and whenever needed.

Another feature of street lighting system 500 is the ability of lighting control units 100 to communicate directly with driverless cars or driver assisted automotive intellegence. Control units 100 in street lighting system 500 in general are located on street poles at a height above the street, e.g., 6 meters, and system 500 through control units 100 can communicate forward information such as street activity or traffic information or street repair or condition information to smart car on-board computer, and the information may be basically real-time information since system 500 can be continuously monitor traffic, street conditions, and events that may affect traffic. Smart cars of the future and some already on the street are equipped with 360° scanning cameras. Even relatively long range cameras that can scan up to 100 meters can only monitor a limited area and may not be able to detect activity around street corners. A lighting control unit 100 positioned at a street corner may directly communicate around-the-corner information that the cameras or other sensing systems on an automobile cannot detect. This service to the smart cars and may allow smart cars and driverless cars to effectively see around corners.

System 500 may further communicate with Internet services to provide real-time information concerning the area monitored by lighting system 500. For example, Google Street View® is a service that provides views along many streets across the world, and Google Maps® currently shows many streets with Street View imagery available. Such views are particularly useful to help a driver identify a travel destination. One of the main problems with these service is the cost and time required to update street imagery. Conventionally, imagery acquisition or an update requires a vehicle with a camera to travel along a street and capture images or video without upsetting or disrupting other street users. Because of the difficulty in street image data collection, internet based street maps may use street images that are a number of years old. In contrast, system 500 can capture street images to update Google street maps® nearly instantly. System 500 can be constantly viewing and scanning the streets and roads wherever street lighting is employed. As the street images may be stored, e.g., in storage server 560, Google® or other similar services may obtain image data on demand, e.g., from storage server 560, and deliver a up to date street scene service in a simple way.

Environmental module 578 may employ sensor data from environmental pollution sensors fitted to control units 100. Pollution data may, for example, be provided to scientists and the general public with the ability to examine or use pollution data that is highly localized and accurately time indexed. The pollution data may, for example, include extensive time indexed data streams indicating temperatures, levels of vehicle pollutants, CO₂ levels, and particulate levels in a relatively small area around a control unit 100. Alternative, environmental data may reflect transient events such as a detected toxic chemical leak that may rarely or never occur. System 500 has the advantage of providing the necessary service of controlling street lighting, and with little additional cost, scientists and engineers no longer rely on the limited data coming from scarce dedicated monitoring stations. Furthermore, current system dedicated to environmental pollution monitoring generally have a limited set of measurements at widely separated locations, so that the available data from dedicated pollution data may not provide the whole picture, that is may not provide all the information need to understand or analyze environmental conditions. Control units 100 may be located at many locations with a relatively small area to provide environmental data that is less subject to aberrant measurements at a single location, and control units 100 have capabilities such as image and noise recording and analyzed data such as traffic measurements that may provide additional context for the understanding of environmental measurements. For example, control units 100 may be mounted on every streetlight in a town or city so as that the entire town or city can be monitored, and environmental alerts may be generated that are specific to time and location. This may gives scientists a better picture of where, when and why pollution is happening in each town, city, industrial or commercial zone and may allow communities to take the necessary steps to improve the environment. Environmental module 578 may be used as a warning system, e.g., to automatically control sounding if a dangerous event such as a chemical spill is detected. Environmental module 578 may also make specific, real-time environmental information available for the public to access through the Internet 530. Environmental system 578 may also be configured to send, e.g., through texting, e-mail, or voice message to smart phones, environmental alerts to people that register as having specific medical conditions such as asthma or may warn people to avoid specific areas on any given day.

Environmental module 578 may further be used for weather monitoring or prediction. For example, control units 100 may measure atmospheric pressure, wind speed, and temperature and provide measurements to scientists, meteorologists and town and city engineers who in turn will use the information to better understand what is going on with the weather. Control units 100 may make uses of conventional atmospheric sensors that are already in use, but system 500 provides a more innovative approach as part of a town or city mesh that may provide much more data than is currently available. As with pollution measurements, the public or specific individuals may be alerted to any unusual data being collected so as they can decide whether they want to issue warnings or notices to the citizens. The data may also be publically available to the town or city citizens website where the data could be used to make better weather predictions or aid in studies looking at the effect of atmospheric conditions on other environmental systems or can be downloaded.

Another feature of environmental module 578 may be use of control units 100 containing radiation detectors such as micro Geiger counters that may detect radiation levels or doses in specific areas of control units 100. In this way, lighting control units 100 may create a new radiation sensor network covering a specific area, a town or city, or an entire nation. Once a radiation detection network is in place, environmental module 578 may monitor nuclear radiation to detect unsafe radiation levels or doses or to track the movement of radioactive material. Radiation data could be mapped nationally in any country, and media, NGOs and widespread citizen scientists alike could be made aware of potentially affected regions should there be a nuclear station accident. So far those present monitors are few and not located so as to form a regionally affected map of the affected area.

FIG. 6 illustrates a system 600 that uses a network of outdoor light fixtures 300 with lighting control units 100 for lighting of a recreational area 610 such as a ski slope and for creating videos of performances that may include a user 620 traveling through recreational area 610. In one particular example, user 620 is a skier, and area 610 is a ski slope. Outdoor lighting fixtures 300 may be used to provide lighting to improve the experience of user 620 during low natural light conditions, e.g., for evening or night time skiing, and accordingly, light fixtures 300 may be distributed to cover the entire area 610. Lighting control units 100 on light fixtures 300 may be used to turn on illumination at specific times and further have cameras as described above that may capture videos of portions of area 610 at any time. In particular, cameras in lighting control units 100 may constantly produce respective video streams, that an LAU 630 may receive the video streams from lighting control units and may store time indexed image data 632 from all of the control units 100. A tracking module, which in the illustrated example of FIG. 6 is executed or implemented LAU 630, can perform a tracking process such as described above. In particular, video from an initial area of a control unit 100, e.g., the control unit 100 at the top of a ski lift, may be analyzed to detect and distinguish individuals entering are 610. In a ski area, individual skiers may be identified by their height or size, the color of their apparel, and recognizable features of their ski equipment, e.g., equipment logos or color patterns. A time indexed database of individuals may thus be constructed for the initial control unit 100. Similar time indexed databases may be created from analysis of video capture by other control units 100. For a specific user 620, tracking module 634 may use the databases to identify all of the different video clip that show user 620, and the video clips of user 620 may be assembled, e.g., edited together in chronological order, to show user 620 traversing area 610. The assembled video may sold or provided to user 620 as a memento or for use in reviewing and improving technique.

Each of modules described herein may include, for example, hardware devices including electronic circuitry for implementing the functionality described herein. In addition or as an alternative, each module may be partly or fully implemented by a processor executing instructions encoded on a machine-readable storage medium.

All or portions of some of the above-described systems and methods can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

What is claimed is:

1. A lighting control system comprising:
a housing including a socket configured for connection to a complementary socket of an outdoor lamp;
a switching system in the housing and configured to switch on and off power routed through the socket to the outdoor lamp, the switching system being programmable to set one or more switching times when the switch switches on or off the power to the outdoor lamp; and
a camera system in the housing, the camera system being configured to capture images of an environment around the outdoor lamp and to transmit the images to a remote control center.

2. The system of claim 1, further comprising a controller in the housing and configured to program the switching system to turn on the outdoor lamp at a first switching time and turn off the second outdoor lamp at a second switching time.

3. The system of claim 2, wherein the first switching time is set based on a sunrise time at a location of the outdoor lamp and the second switching time is set based on a sunset time at the location of the outdoor lamp.

4. The system of claim 2, wherein the switching system comprises a dimmer, the switching system being programmable to control the dimmer and thereby control the power to the outdoor lamp.

5. The system of claim 4, wherein the controller is configured to control the dimmer.

6. The system of claim 5, further comprising energy monitor connected to measure the power consumption in or through the lighting control system.

7. The system of claim 6, wherein the energy monitor comprises a current sensor and a voltage sensor adapted to calculate RMS values of the energy consumption of the outdoor lamp.

8. The system of claim 2 further comprising a communication interface coupled to the controller, the controller being further configured to execute commands received through the communication interface, execution of the commands implementing remote management of the system and the outdoor lamp.

9. The system of claim 1, further comprising a motion sensor in the housing, the motion sensor be configured to trigger operation of the camera system to capture or transmit the images in response to the motion sensor detecting movement of a human or a vehicle in the environment around the outdoor lamp.

10. The system of claim 1, wherein the camera system comprises an IP-based system configured to turn the images into data and transmit the data through a network.

11. The system of claim 1, further comprising a controller configured to receive image data from the camera system and provide one or more of pattern recognition, gait recognition, facial recognition that distinguishes people or vehicle from the image data.

12. The system of claim 11, wherein the controller is further configured to transmit to a remote recipient, vehicle data corresponding to one or more vehicles in the environment around the outdoor lamp.

13. The system of claim 12, wherein the vehicle data indicates a time and one or more locations of the one or more vehicles at the time.

14. The system of claim 1, further comprising:
a sound sensor; and
a controller configured to identify one or more different noises detected by the sound sensor.

15. The system of claim 14, further comprising:
one or more sensors; and
a controller configured to receive measurement data from the one or more sensors and to use the measurement data to compose a message that the controller sends to remote recipient.

16. The system of claim 15, wherein the one or more sensors are selected from a group consisting of:
a sound sensor configured to sense sounds in the environment around the outdoor lamp;
a pressure sensor configured to measure atmospheric pressure in the environment around the outdoor lamp;
a pollution sensor configured to measure or detect pollution in the environment around the outdoor lamp; and
a radiation detector configured to measure radiation in the environment around the outdoor lamp.

17. The system of claim 1, wherein the camera system is configured to capture images showing facilities in the environment around the outdoor lamp in details sufficient for an inspection process to identify defects in the facilities from the images.

18. The system of claim 1, wherein the facilities include street surfaces, and the defects include potholes.

19. The system of claim 1, further comprising a communication interface configured to transmit navigation data to vehicles in the environment of the outdoor lamp.

20. The system of claim 1, wherein the outdoor lamp comprises a streetlight.

21. The system of claim 1, wherein the remote control center is under control of a law enforcement agency or an emergency response agency.

22. A computing system for organizing image data from a plurality of lighting control units respectively controlling a plurality of outdoor lamps, wherein:
each of the lighting control units is mounted on the outdoor lamp that the lighting control unit controls;
each of the lighting control units comprises a camera module configured to collect image data and transmit the data to the computing system;
the computing is configured to organize clips of the image data from the lighting control units for display in a sequence of the clips that have time stamps in a first range and that are from the outdoor lamps at a plurality of locations in a second range of locations of the outdoor lamps.

23. The computing system of claim 22, wherein the sequence comprises a video file, and the computing system is configured to transmit the video file for a person to view.

24. The computing system of claim 22, wherein the sequence of the clips of the image data includes only the clips of the image data that represents an activity of a targeted object.

25. The computing system of claim 24, wherein:
the outdoor lamps comprise a plurality of street lights; and
the targeted object is a vehicle or a person traversing an area containing the street lights.

26. The computing system of claim 24, wherein:
the outdoor lamps are positioned to illuminate a recreational area; and
the targeted object is a person traversing the recreational area.

27. The computing system of claim 16, wherein the recreational area comprises a ski slope, and the person is a skier.

28. A timing-cell for controlling a street lamp, comprising:
a time-based switch configured to switch on or off the street lamp based on daily sunset and sunrise times at a location of the street light; and
a camera module configured to collect image data and transmit the data to a remote location, wherein the camera module is adapted as a motion-triggered surveillance camera to capture a video or an image in an environment around the street lamp.

29. The timing-cell of claim 28, further comprising:
one or more sensors; and
a controller configured to receive measurement data from the one or more sensors and to use the measurement data to compose a message that the controller sends to remote recipient.

30. The system of claim 29, wherein the one or more sensors are selected from a group consisting of:
a sound sensor configured to sense sounds in the environment around the outdoor lamp;
a pressure sensor configured to measure atmospheric pressure in the environment around the outdoor lamp;
a pollution sensor configured to measure or detect pollution in the environment around the outdoor lamp; and
a radiation detector configured to measure radiation in the environment around the outdoor lamp.

31. A method for operating an outdoor lamp comprising:
identifying a location of the outdoor lamp; and
for each of a plurality of days of operation of the outdoor lamp, operating a processing system to:
determine a first time and a second time based on a sunrise time at the location on the day of operation and a sunset time at the location on the day of operation; and
setting a switching system to turn on the outdoor lamp at the first time on the day of operation and turn off the outdoor lamp at the second time on the day of operation.

32. The process of claim 31, wherein identifying the location of the outdoor lamp comprising determining GPS coordinates of the outdoor lamp during an installation process.

33. The process of claim 32, wherein the installation process installs a lighting control unit on the outdoor lamp, the lighting control unit containing the switching system.
